(19) United States
(12) Patent Application Publication
(10) Pub. No.: US 2009/0267583 A1
(43) Pub. Date: Oct. 29, 2009

(54) Switching power supply apparatus with current output limit

(76) Inventors: Te-Hsien Hsu, Hsinchu City (TW); Yun-Kang Chu, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/230,959

(22) Filed: Sep. 9, 2008

(30) Foreign Application Priority Data
Apr. 23, 2008 (TW) 97114801

(51) Int. Cl. G05F 1/10

(52) U.S. Cl. 323/284

(57) ABSTRACT

A switching power supply apparatus with current output limit, which utilizes a voltage sampling controller for sampling the feedback voltage to acquire a knee voltage. Moreover, the knee voltage is computed by the square-root operation and error elimination operation respectively. According to the result of the computing, the switching of the power switch is controlled so as to stabilize the output voltage and limit the output current.

### BACKGROUND OF THE INVENTION

1. Field of the Invention

The present invention is related to a switching power supply apparatus capable to limit output current, and in particular to a switching power supply apparatus in which the output current can be kept unchanged even the output voltage descends when the output current limitation has reached, in order to provide the function of output over-current protection.

2. Description of Related Art

In present, the switching power supply has already takes over the market of the linear stabilizing power supply. The switching power supply relies on the width of a pulse signal to adjust and control the conducting and cut-off time of the power switch so as to achieve the purpose of generation of stabilized voltage on the secondary side. The output power on the secondary side, the output voltage, and the output current are utilized to generate a feedback signal for modulating the pulse wide adjusting controller to generate a pulse signal with suitable width.

The primary side feedback control switching power supply of the prior art cannot fulfill the requirement of voltage rippler under various output voltages. Therefore, most of the switching power supplies still need the photo-coupler and feedback voltage stabilizing circuit for transmitting a secondary side feedback signal. As a result, photo-coupler, feedback voltage stabilizing circuit, operational amplifier and current limit components are necessary for the switching power supplies.

FIG. 1 shows a circuit diagram of a secondary side feedback control switching power supply of the prior art, which is suitable for high precision, high power and high output current applications. It employs the operational amplifiers U4A, U4B, the feedback voltage stabilizer U3, and the photo-coupler U2 as the control components for voltage feedback and current limit to control the operation of the adjuster U1 for adjusting primary side pulse width so as to achieve the object of voltage stabilization and current limitation. Although this circuit is suitable for high precision application, it requires lots of components and thus has a drawback of high fabrication cost.

FIG. 2 shows a circuit diagram of a prior art primary side feedback control switching power supply. When the power switch Q1 is conducted, the energy cannot be transmitted from the primary side to the output terminal V_{O} because polarity of the diode D3 is opposite to that of the secondary winding, and is temporarily stored in the transformer T1. As the voltage level on the upper end of the primary side current detection resistor R6 reaches a reference voltage, the power switch Q1 is cut-off. At this time, since the polarity of the diode D3 and that of the secondary windings are identical, the energy stored in the transformer T1 can be transmitted to the output terminal V_{O}. The output capacitor C4 is charged with multiple cycles and performs the effect of voltage stabilization. Because the voltage drop in the output rectifying diode D3 varies with respect to the loading and the voltage crossing the capacitor C6 changes with respect to the conducting cycle of the power switch Q1, the voltage detection on the primary side capacitor C6 cannot completely reflect the variations on the secondary side output voltage V_{O}. Therefore, the voltage ripple of the output voltage is higher than that of the secondary side feedback control switching power supply. Therefore, the primary side feedback control switching power supply cannot provide stable voltage output. Additionally, such a prior art primary side feedback control switching power supply does not have a current limit circuit for restricting the output current when the output voltage V_{O} descends. However, such a circuit has the advantage of saving several unnecessary feedback components found in the secondary side feedback control switching power supply as shown in FIG. 1.

Consequently, the present invention aims to provide a desirable switching power supply in which, when the output reaches the current limit, the output voltage descends but the output current can be controlled to remain unchanged, so as to achieve the objective of over-current protection.

### SUMMARY OF THE INVENTION

In view of the aforementioned issues, a switching power supply apparatus with current output limit according to the present invention is provided, which features a voltage sampling and holding controller for accessing a feedback voltage of a knee voltage. The knee voltage is then computed by square-root operation and error-amplifying operation respectively. The computing result is utilized to control the switching of the power switch so as to stabilize the output voltage and limit the output current.

The first embodiment of the switching power supply apparatus with current output limit according to the present invention comprises a transformer, a power switch, a current detector, a feedback signal processor, a square-root generator, and a switch controller. The transformer receives an input voltage by the primary winding thereof and inductively outputs an output voltage through the output terminal of the transformer. Meanwhile, the auxiliary winding of the transformer inductively outputs a feedback voltage. The power switch is coupled to the primary winding of the transformer. The current detector is coupled to the power switch, receives a current from the primary winding of the transformer through the power switch, and outputs a current detection signal. The feedback signal processor is coupled to the auxiliary winding of the transformer for generating a feedback signal based on the feedback voltage. The square-root generator is coupled to the feedback voltage processor, which performs square-root computations on the feedback signal and outputs a current limit control signal. The switch controller is coupled to the power switch, the square-root generator, and the current detector, compares the current detection signal with the current limit control signal and outputs a driving signal to the power switch based on the comparison result to control the switching of the power switch.

In contrast with the first embodiment, the second embodiment of the switching power supply apparatus with current output limit according to the present invention further comprises an error amplifier and a voltage level adjuster. The error amplifier is coupled to the feedback signal processor and the voltage level adjuster. The voltage level adjuster is coupled between the error amplifier and the switch controller. The error amplifier compares a reference voltage with the feedback signal, and also outputs an amplified error signal to the voltage level adjuster. The voltage level adjuster adjusts voltage level of the received amplified error signal and outputs a voltage control signal to the switch controller. At this time, the switch controller, which is coupled to the power switch, the square-root generator, the voltage level adjuster, and the current detector, compares the current detection signal with the current limit control signal or compares the current detection signal with the voltage control signal, and based on the comparison result, outputs a driving signal to the power switch to control the switching of the power switch.

The differences between the first embodiment and the third embodiment of the switching power supply apparatus with current output limit according to the present invention lie in that, the feedback signal processor of the third embodiment is coupled to the secondary winding of the transformer, acquires a feedback voltage by sampling the voltage level on the secondary winding of the transformer, and generates a feedback signal according to the feedback voltage. While in contrast with the first embodiment, the square-root generator of the third embodiment similarly performs square-root operation on the feedback signal and outputs a current limit control signal. Besides, the switch controller of the third embodiment is analogously used to compare the current detection signal with the current limit control signal, and outputs a driving signal to the power switch based on the comparison result to control the switching of the power switch when in a protection status.

In contrast with the third embodiment, the fourth embodiment of the switching power supply apparatus with current output limit according to the present invention further comprises an error amplifier and a voltage level adjuster. The error amplifier is coupled to the feedback signal processor and the voltage level adjuster. The voltage level adjuster is coupled between the error amplifier and the switch controller. The error amplifier compares a reference voltage with the feedback signal, and also outputs an amplified error signal to the voltage level adjuster. The voltage level adjuster adjusts voltage level of the received amplified error signal and outputs a voltage control signal to the switch controller. At this time, the switch controller, which is coupled to the power switch, the square-root generator, the voltage level adjuster and the current detector, compares the current detection signal with the current limit control signal or compares the current detection signal with the voltage control signal, and based on the comparison result, outputs a driving signal to the power switch to control the switching of the power switch.

In summary, as described supra, the switching power supply apparatus with current output limit according to the present invention can keep the current unchanged in the situation that output voltage descends and the output current reaches a current limit so as to provide the function of output current protection.

The above-mentioned summary and the following detailed descriptions are simply exemplary for further illustrating the claims of the present invention. Other objectives and advantages related to the present invention will be further set out in the subsequent descriptions and appended drawings.

### BRIEF DESCRIPTION OF THE DRAWINGS

FIG. 1 shows a circuit diagram of a prior art secondary side feedback control switching power supply;

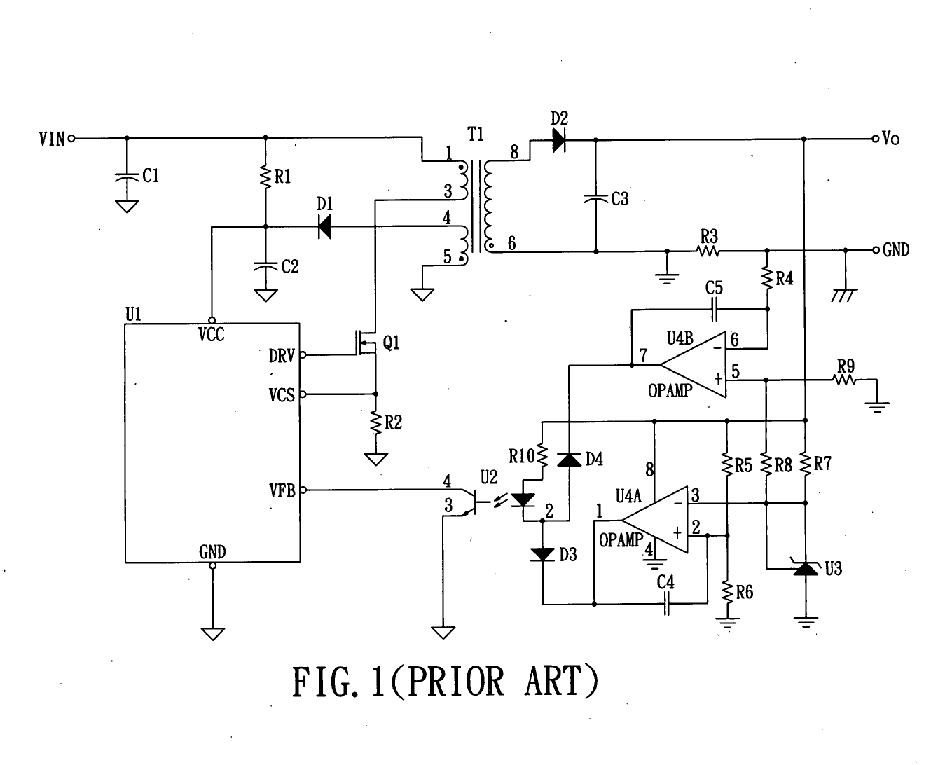

FIG. 2 shows a circuit diagram of a prior art primary side feedback control switching power supply;

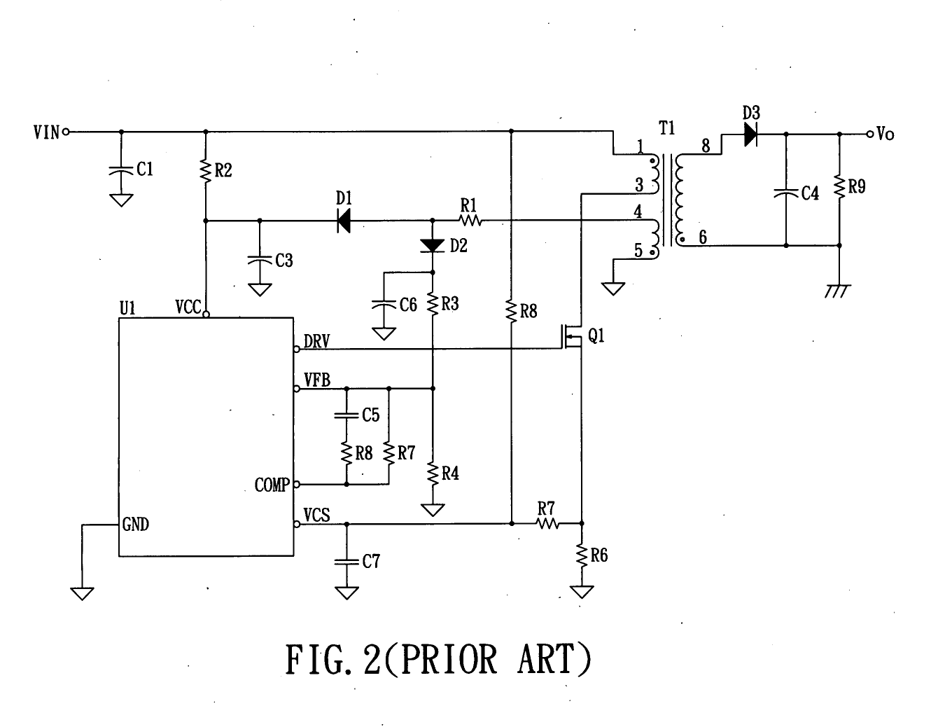

FIG. 3 shows a circuit diagram of a first embodiment of the switching power supply apparatus with current output limit according to the present invention;

FIG. 4 shows a circuit diagram of a second embodiment of the switching power supply apparatus with current output limit according to the present invention;

FIG. 5 shows a circuit diagram of a third embodiment of the switching power supply apparatus with current output limit according to the present invention;

FIG. 6 shows a circuit diagram-of a fourth embodiment of the switching power supply apparatus with current output limit according to the present invention;

FIG. 7 shows a circuit diagram of the switch controller used in the first and the third embodiments according to the present invention;

FIG. 8 shows a circuit diagram of the switch controller used in the second and the fourth embodiments according to the present invention;

FIG. 9 is a waveform diagram showing the signals used in the switching power supply apparatus with current output limit according to the present invention;

FIG. 10 is a diagram showing the relationship between the output current and the output voltage according to the present invention;

FIG. 11A shows a circuit diagram of a first embodiment of the feedback signal processor according to the present invention;

FIG. 11B is a schematic view showing a second embodiment of the feedback signal processor according to the present invention; and

FIG. 12 shows a circuit diagram of the square-root generator according to the present invention.

### DETAILED DESCRIPTION OF PREFERRED EMBODIMENTS

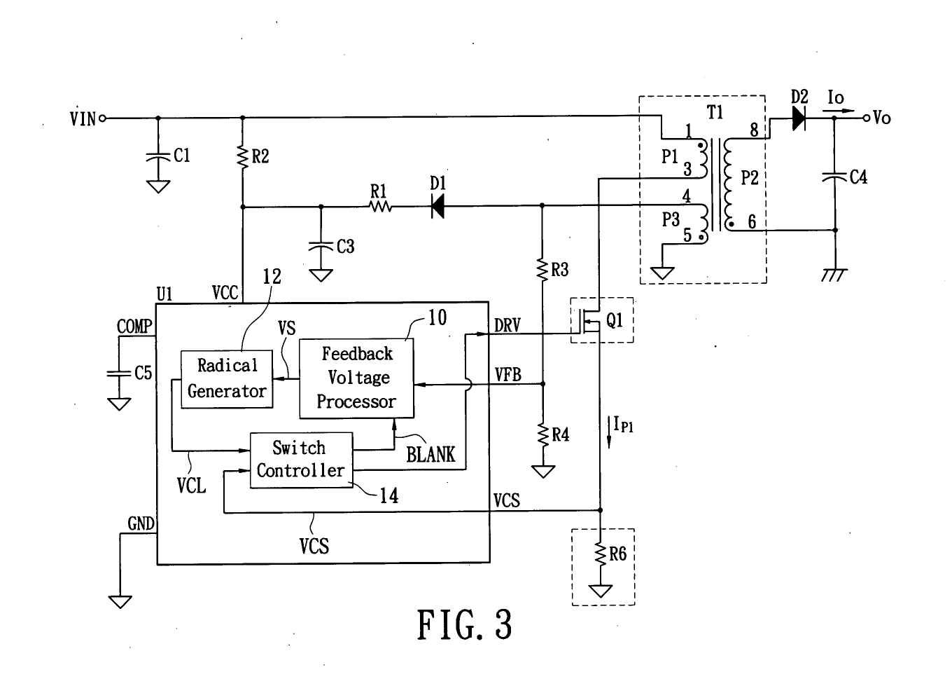

Refer to FIG. 3, wherein a circuit diagram of a first embodiment of the switching power supply apparatus with current output limit according to the present invention is shown. The switching power supply apparatus with current output limit comprises a transformer T1, a power switch Q1, a current detector R6, and a pulse width adjustment (PWM) controller U1. Transformer T1 receives an input voltage VIN by the primary winding P1 thereof and inductively outputs an output voltage V_{O} through the secondary winding P2 of the transformer T1. Meanwhile the transformer T1 inductively outputs a feedback voltage VFB through the auxiliary winding P3 thereof. The power switch Q1 is coupled to the primary winding P1 of the transformer T1. The current detector R6 is coupled to the power switch Q1 for receiving a primary winding current I_{P1} from the transformer T1 through the conducting power switch Q and outputting a current detection signal VCS.

The pulse width adjustment controller U1 comprises a feedback signal processor 10, a square-root generator 12, and a switch controller 14. The feedback signal processor 10 is a voltage sampling and holding controller and is coupled to the auxiliary winding P3 of the transformer T1 to generate a feedback signal VS based on the feedback voltage VFB. The square-root generator 12 is coupled to the feedback signal processor 10 for performing square-root operation on the feedback signal VS and outputting a current limit control signal VCL. The switch controller 14 is coupled to the power switch Q1, the feedback signal processor 10, the square-root generator 12, and the current detector R6. When in the protection status, the switch controller 14 compares the current detection signal VCS with the current limit control signal VCL and outputs a driving signal DRV to the power switch Q1 based on the comparison result to control the switching of the power switch Q1.

Besides, the switch controller 14 also outputs a blank signal BLANK to the feedback signal processor 10 based on the comparison result to delay the signal processing sequence of the feedback signal processor 10 to avoid the influence caused by voltage ringing of the feedback voltage VFB, so as to appropriately sample the feedback voltage VFB.

Referring again to FIG. 3, when the power switch Q1 is conducted, peak value I_{PK} of the primary winding current I_{P2} of the transformer T1 can be expressed by the following formula (1):

$${I}_{PK} = \frac{{V}_{IN} \times {T}_{ON}}{{L}_{M}} \qquad ( 1 )$$

In formula (1), V_{IN} means the input voltage, L_{M} is the inductance of the primary winding of the transformer T₁, and T_{ON} is the conducting time of the power switch Q1.

According to formula (1), the input power P_{I} of the power supply apparatus can be obtained by formula (2) as below.

$${P}_{I} = \frac{{V}_{IN}^{2}}{2 {L}_{M}} \times \frac{{T}_{ON}^{2}}{{T}_{S}} \qquad ( 2 )$$

In formula (2), T_{S} is the switching cycle of the power switch Q1.

Meanwhile, the output power P_{O} of the power supply apparatus can be obtained by formula (3) as below.

P_{O}=P₁×η=V_{O}×I_{O} (3)

In formula (3), η is the power conversion efficiency, V_{O} means output voltage, and I_{O} means output current.

With reference to formulas (1), (2) and (3), formula (4) can be thereby inferred as below.

$${I}_{O} = \frac{{P}_{O}}{{V}_{O}} = \frac{{V}_{IN}^{2}}{2 {L}_{M}} \times \frac{{T}_{ON}^{2}}{{T}_{S} \times {V}_{O}} \times η = \frac{η \times {L}_{M}}{2 \times {T}_{S}} \times \frac{{I}_{PK}^{2}}{{V}_{O}} \qquad ( 4 )$$

Referring to formula (4), let the output current I_{O} be a constant, the relationship between the output voltage V_{O} and the peak value I_{PK} of the primary winding current I_{P1} can be derived by formula (5) hereunder.

$${I}_{PK} = \frac{{V}_{PK}}{R} = {K}_{1} \times \sqrt{{V}_{O}} \qquad ( 5 )$$

In formula (5), K₁ is a constant and R means the resistance of the current detector R6. According to formula (5), it can be concluded that, as long as the relationship I_{PK}=K₁×√ V_{O} can be achieved, the output current I_{O} can be maintained at a constant. At the same time, the peak value I_{PK} of the primary winding current I_{P1} is generated flowing through the current detector R6 and thereby a voltage peak value V_{PK} of the current detection signal V_{CS} can be detected on the current detector R6.

In summary, the square-root generator 12 of the present invention is used to perform square-root operation on the feedback signal VS, which is proportional to the output voltage V_{O}. Thus, the current limit control signal VCL outputted by the square-root generator 12 is proportional to square-root of output voltage V_{O} (i.e. √ V_{O}). Then, by the conclusion derived from formula (5), the switch controller 14 of the present invention compares the current detection signal VCS with the current limit control signal VCL and controls the switching of the power switch Q1 according to the comparison result. In this way, in the first embodiment of the switching power supply apparatus with current output limit according to the present invention, the output current I_{O} can be kept unchanged after the output current 10 reaches the current limit and the output voltage descends.

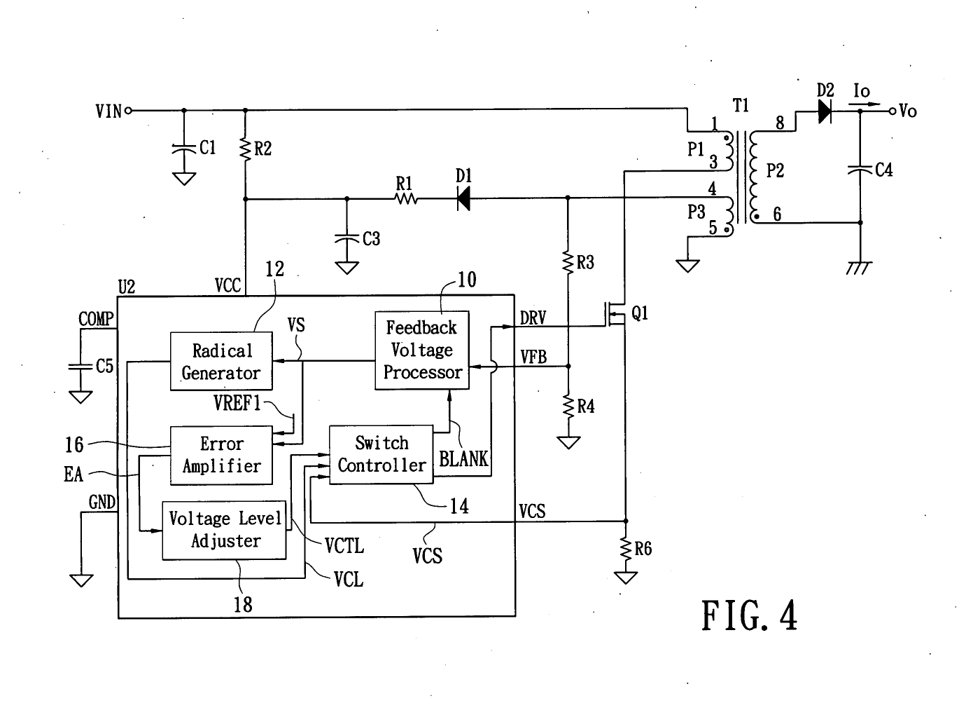

FIG. 4 shows a second embodiment of the switching power supply apparatus with current output limit according to the present invention. Referring to FIGS. 3 and 4, the components in the second embodiment which are identical to the counterparts in the first embodiment are labeled with the same symbols. As shown, the operation principle and the function of the first and the second embodiments are identical. The major differences between the first and the second embodiments exist in that the pulse width adjustment controller U2 in the second embodiment further has an error amplifier 16 and a voltage level adjuster 18. The error amplifier 16 is coupled to the feedback signal processor 10 and the voltage level adjuster 18. The voltage level adjuster 18 is coupled between the error amplifier 16 and the switch controller 14. The error amplifier 16 compares a reference voltage VREF1 with the feedback signal VS and outputs an amplified error signal EA to the voltage level adjuster 18. The voltage level adjuster 18 adjusts voltage level of the amplified error signal EA to output a voltage control signal VCTL to the switch controller 14. At this moment, the switch controller 14, which is coupled to the power switch Q1, the square-root generator 12, the voltage level adjuster 18, and the current detector R6, compares the current detection signal VCS with the current limit control signal VCL when in a protection status, or compares the current detection signal VCS with the voltage control signal VCTL when in a normal status. In addition, the switch controller 14 based on the comparison result outputs the driving signal DRV to the power switch Q1 to control the switching of the power switch Q1 so as to achieve the dual functions of output voltage stabilization and current limitation.

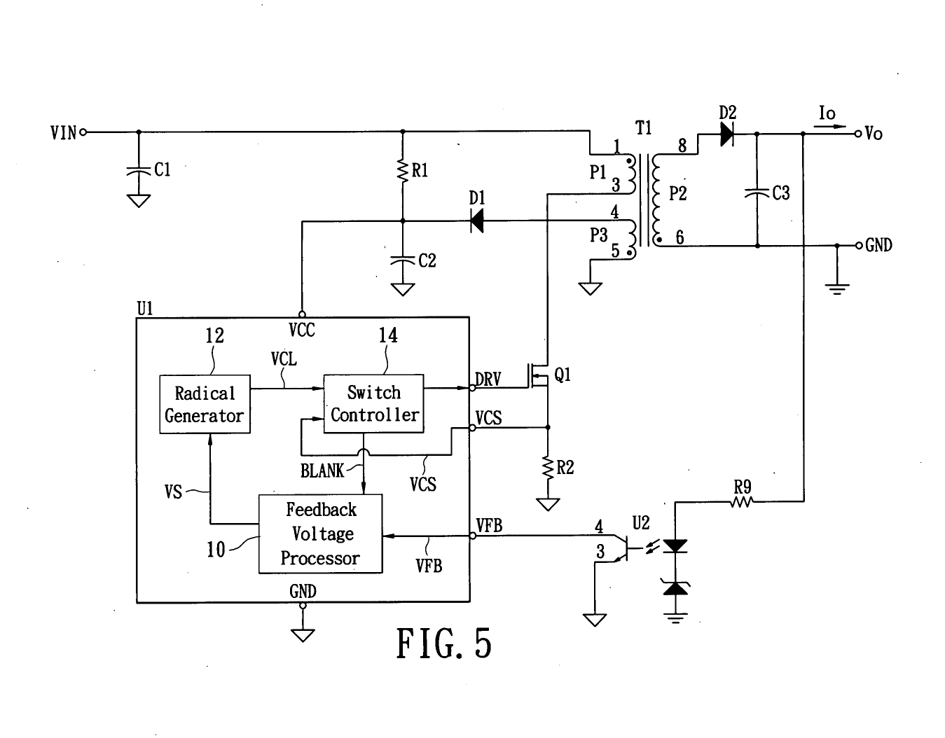

FIG. 5 shows a third embodiment of the switching power supply apparatus with current output limit according to the present invention. Referring to FIGS. 3 and 5, the components used in the third embodiment which are identical to the counterparts in the first embodiment are labeled with the same symbols. The operation principle and function of the first and the third embodiments are identical. The major differences between the two embodiments exist in that the feedback signal processor 10 in the third embodiment according to the present invention is coupled to the secondary winding P2 of the transformer T1 and acquires the feedback voltage VFB by sampling the voltage level on the secondary winding P2 of the transformer T1 via a photo-coupler U2, and generates a feedback signal VS based on the feedback voltage VFB. While in contrast with the first embodiment, the square-root generator 12 of the third embodiment according to the present invention similarly performs square-root operation on the feedback signal VS and outputs a current limit control signal VCL. The switch controller 14 is also used to compare the current detection signal VCS with the current limit control signal VCL when in protection status and controls the switching of the power switch Q1 according to the comparison result. In this way, in the third embodiment of the switching power supply apparatus with current output limit according to the present invention, the output current I_{O} can be kept unchanged when the output current I_{O} reaches the current limit and the output voltage descends.

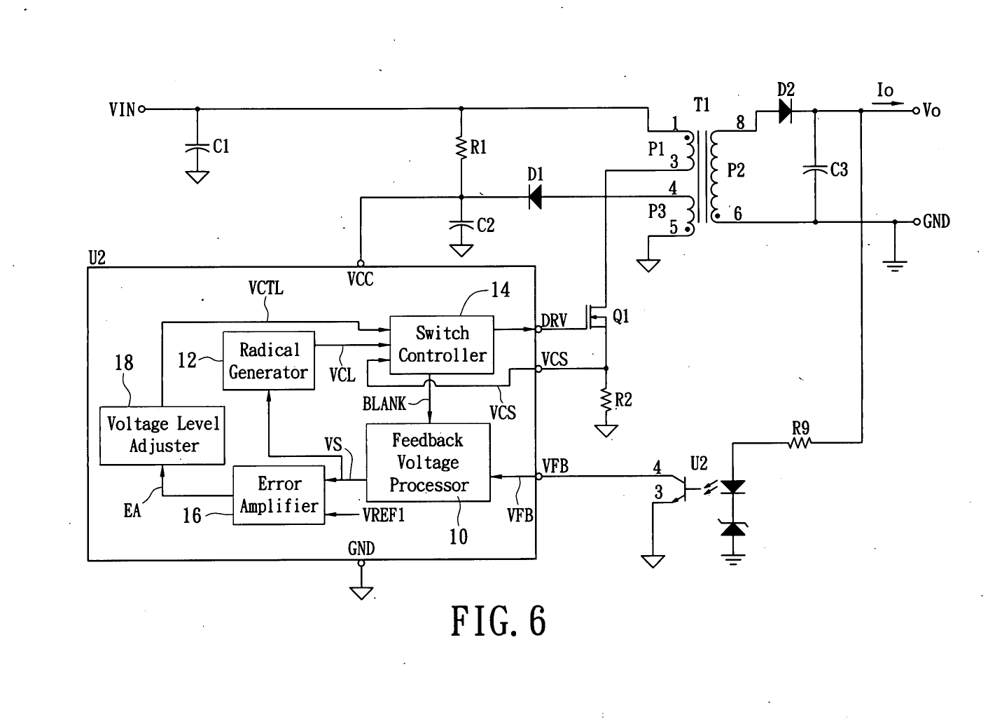

FIG. 6 shows a fourth embodiment of the switching power supply apparatus with current output limit according to the present invention. Referring to FIGS. 6 and 5, the components used in the fourth embodiment which are identical to the counterparts in the third embodiment are labeled with the same symbols. The operation principle and the function of the fourth and the third embodiments are identical. The major differences exist in that the pulse with adjustment controller U2 in the fourth embodiment further has an error amplifier 16 and a voltage level adjuster 18. The error amplifier 16 is coupled to the feedback signal processor 10 and the voltage level adjuster 18. The voltage level adjuster 18 is coupled between the error amplifier 16 and the switch controller 14. The error amplifier 16 compares a reference voltage VREF1 with the feedback signal VS and outputs an amplified error signal EA to the voltage level adjuster 18. The voltage level adjuster 18 adjusts voltage level of the amplified error signal EA to output a voltage control signal VCTL to the switch controller 14.

At this time, the switch controller 14, which is coupled to the power switch Q1, the square-root generator 12, the voltage level adjuster 18, and the current detector R2, compares the current detection signal VCS with the current limit control signal VCL when in a protection status, or compares the current detection signal VCS with the voltage control signal VCTL when in a normal status. In addition, based on the comparison result, the switch controller 14 outputs the driving signal DRV to the power switch Q1 to control the switching of the power switch Q1 so as to achieve the dual functions of output voltage stabilization and current limitation.

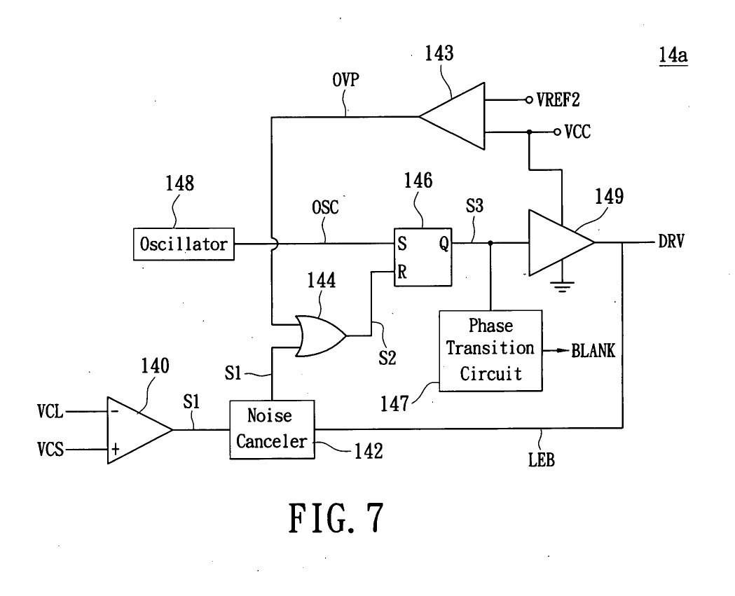

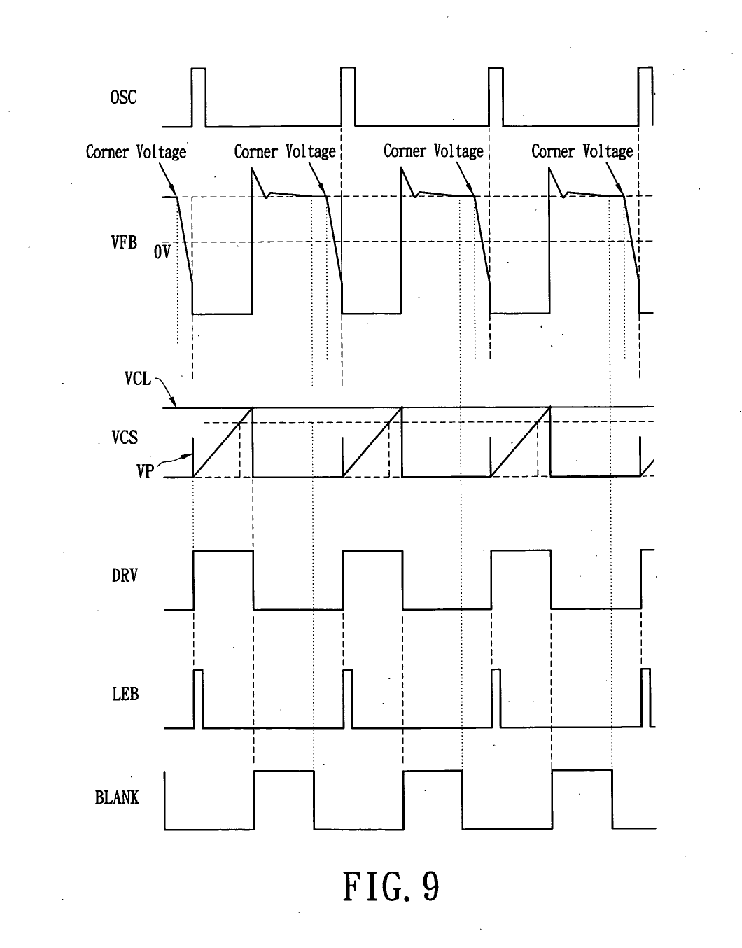

FIG. 7 shows a circuit block diagram of the switch controller used in the first and the third embodiments according to the present invention. FIG. 9 is a waveform diagram showing the signals used in the switching power supply apparatus according to the present invention. Referring to FIG. 7 in conjunction with FIGS. 3 and 5, the switch controller 14a consists of a comparator 140, a noise eliminator 142, an over-voltage protection device 143, an OR gate 144, an oscillator 148, a flip-flop 146, a driver 149 and a phase shift circuit 147.

The first inverting input terminal (−) of the comparator 140 is coupled to the square-root generator 12 for receiving the current limit control signal VCL. The non-inverting input terminal (+) of the comparator 140 is coupled to -the current detectors R6/R2 for receiving the current detection signal VCS. Additionally, the output terminal of the comparator 140 outputs a cut-off signal S1 when the current detection signal VCS is greater than the current limit control signal VCL.

Furthermore, the noise eliminator 142 is coupled to the output terminal of the comparator 140 and the power switch Q1. The noise eliminator 142 outputs a noise elimination signal LEB to the control input (not shown) of the power switch Q1 based on the cut-off signal SI, in order to eliminate the front edge noise voltage VP of the current detection signal VCS. After the noise elimination signal LEB has been output, the noise eliminator 142 transfers the cut-off signal SI to the first input end of the OR gate 144. The second input end of the OR gate 144 is coupled to the over-voltage protection device 143 so as to receive a protection signal OVP outputted from the over-voltage protection device 143. Hence, the OR gate 144 may perform logical OR operation on the cut-off signal SI and the protection signal OVP to output a reset signal S2 to the flip-flop 146. The over-voltage protection device 143 outputs the protection signal OVP when the comparison result is that of the power source voltage VCC is greater than a reference voltage VREF2.

The reset terminal (R) of the flip-flop 146 is coupled to the output terminal of the OR gate 144 for receiving the reset signal S2. The setup terminal (S) of the flip-flop 146 is coupled to the output terminal of the oscillator 148 for receiving a conducting signal OSC from the oscillator 148. The flip-flop 146 outputs a control signal S3 from the output terminal (Q) thereof based on the reset signal S2 and the conducting signal OSC.

When the oscillator 148 outputs the high-level conducting signal OSC to the setup terminal (S) of the flip-flop 146, the output terminal (Q) of the flip-flop 146 generates a high-level control signal S3 to control the driver 149 outputting the high-level driving signal DRV to the power switch Q1 to switch the power switch Q into a conducting state. Furthermore, when the current detection signal VCS is greater than the current limit control signal VCL, the high-level cut-off signal S1 output by the comparator 140 is transferred to the reset terminal (R) of the flip-flop 146 through the noise eliminator 142 and the OR gate 144. The output terminal (Q) of the flip-flop 146 generates the low-level control signal S3 to control the driver 149 outputting the low-level driving signal DRV to the power switch Q1 to switch the power switch Q1 into a non-conducting state.

Accordingly, the switch controller 14a repeatedly controls the switching of the power switch Q1, such that the output current I_{O} of the switching power supply apparatus with current output limit according to the present invention can be kept unchanged when the output current 10 reaches the current limit and the output voltage descends.

In conjunction with FIGS. 3 and 5, the phase shift circuit 147 in the switch controller 14a is coupled to the output terminal (Q) of the flip-flop 146 and the feedback signal processor 10. The phase shift circuit 147 outputs a blank signal BLANK to the feedback signal processor 10 to delay the sampling sequence of the feedback signal processor 10 until the blank signal BLANK has passed away, so as to avoid the voltage ringing area in the feedback voltage VFB from being sampled by the feedback signal processor 10. Thus, the knee voltage in the feedback voltage VFB can be precisely sampled to generate the feedback signal VS.

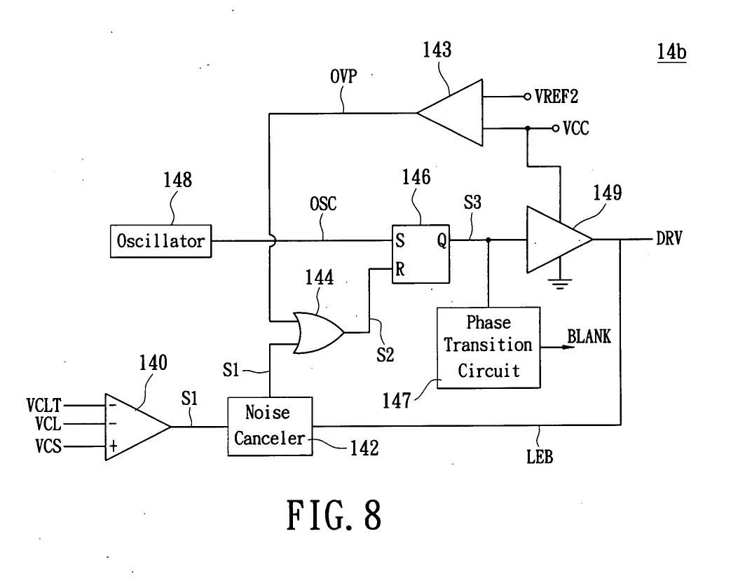

FIG. 8 shows a circuit diagram of the switch controller used in the second and the fourth embodiments according to the present invention. Referring to FIGS. 7 and 8, the components of the switch controller 14b in FIG. 8 which are identical to the counterparts of the switch controller 14a in FIG. 7 are labeled with identical symbols. The operation principle and the function of the switch controller 14b in FIG. 8 are identical to that of the switch controller 14a in FIG. 7. The major differences exist in that the comparator 140 used in the switch controller 14b further comprises a second inverting input terminal (−). The second inverting input terminal (−) is coupled to the error amplifier 16 for receiving the voltage control signal VCTL. Thus, the comparator 140 may output the cut-off signal S1 either when the current detection signal VCS being greater than the current limit control signal VCL or when the current detection signal VCS being greater than the voltage control signal VCTL.

Referring again to FIG. 8, the power switch Q1 is switched into conducting state as the conducting signal OSC outputted by the oscillator 148 is high, and is switched into non-conducting state in accordance with the cut-off signal S1. In this way, the switch controller 14b of the present invention repeatedly controls the switching of power switch Q1, such that the output current I_{O} of the switching power supply apparatus with current output limit according to the present invention can be kept unchanged when the output current I_{O} reaches the current limit and the output voltage descends.

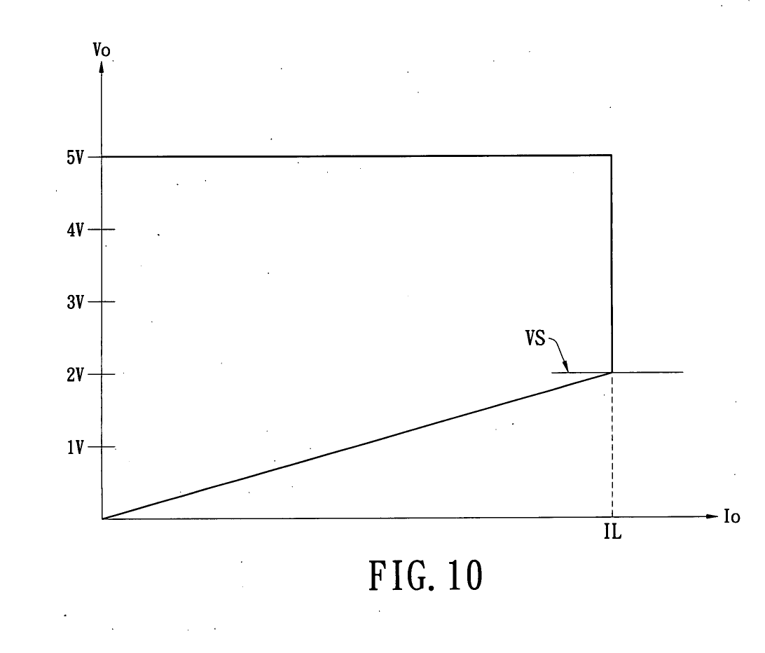

FIG. 10 is a diagram showing the relationship between the output current and the output voltage according to the present invention. Referring to FIGS. 8 and 10, when the output current I_{O} has not reached the current limit value IL, the output voltage V_{O} is at 5V, and the comparator 140 compares the current detection signal VCS with the voltage control signal VCTL to stabilize the output voltage V_{O} at 5V. Meanwhile, when the output current I_{O} reaches the current limit value IL, the output voltage V_{O} and the output power P_{O} start to descend. However, at this time, the comparator 140 compares the current detection signal VCS with the current limit control signal VCL to stabilize the output current I_{O} at the current limit value IL. Besides, as the output voltage V_{O} continues descending to a preset value VPS, the output current I_{O} reduced to zero.

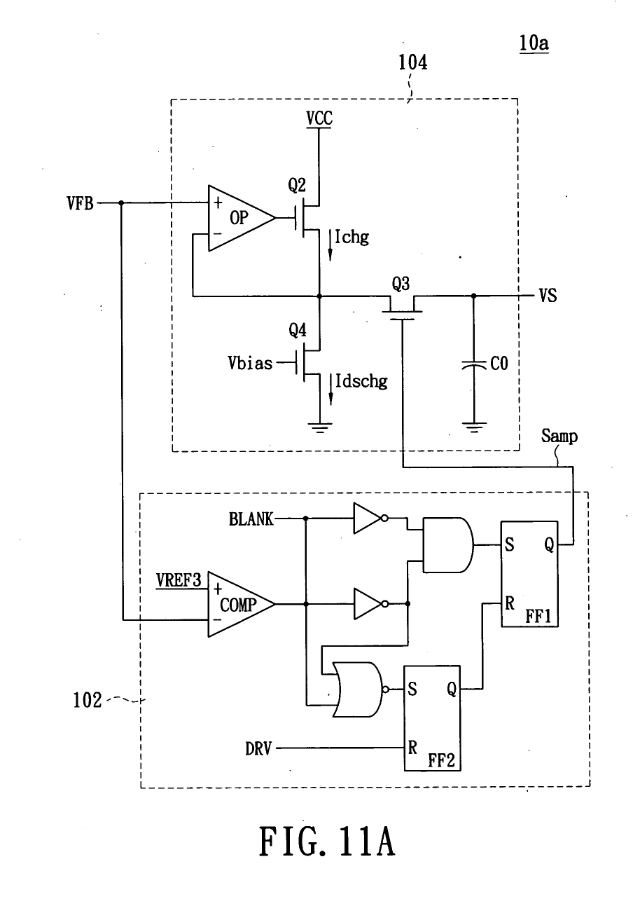

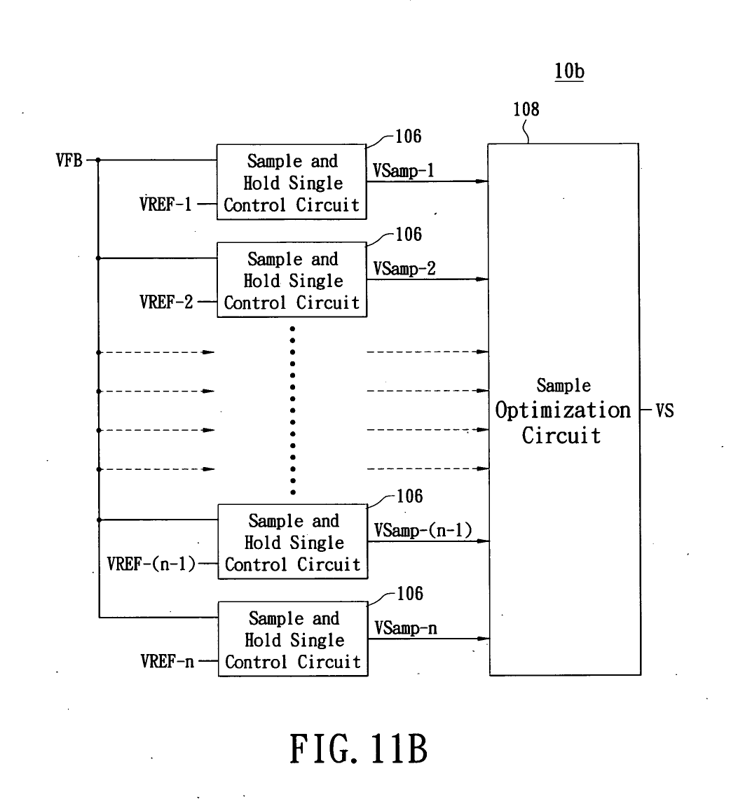

FIG. 11A shows a circuit diagram of a first embodiment of the feedback signal processor according to the present invention. Referring to FIG. 11A in conjunction with FIGS. 3 to 6, the feedback signal processor 10 is a voltage sampling and holding controller 10a and comprises a control circuit 102 and a sampling circuit 104. The control circuit 102 is coupled to the auxiliary winding P3 or secondary winding P2 of the transformer T1 and acquires the feedback voltage VFB from the auxiliary winding P3 or secondary winding P2. The control circuit 102 compares the feedback voltage VFB with a reference voltage VREF3, and outputs a sampling control signal Samp. The sampling circuit 104 is coupled to the control circuit 102. The sampling circuit 104 is controlled by the sampling control signal Samp to acquire a knee voltage on the feedback voltage VFB and hold the knee voltage. The knee voltage is then outputted to generate the feedback signal VS.

In the control circuit 102, the comparator COMP compares the feedback voltage VFB and the reference voltage VREF3 to determine whether to sample or to hold. Assume that the feedback voltage VFB being greater than the reference voltage VREF3 indicates sampling status. After the blank signal BLANK has passed away, the comparison result from the comparator COMP enables the output terminal of the flip-flop FF1 to generate the sampling control signal Samp with high-level voltage for switching the switch Q3 into conducting state. Meanwhile, the feedback voltage VFB input to the amplifier OP to have the charge-discharge current controllers (Q2, Q4) following the variation of the feedback voltage VFB to charge the capacitor C0. Since there is a sudden slope change at the corner of the waveform of the feedback voltage VFB, the voltage sampling and holding controller 10a is capable to acquire the knee voltage of the feedback voltage VFB. In addition, for rapidly charging the capacitor C0, the charging current Ichg of the controller Q2 is designed to be several times greater than the discharging current Idschg of the controller Q4.

Besides, when the feedback voltage VFB is smaller than the reference voltage VREF3, the voltage sampling and holding controller 10a is in hold status. At this time, the comparator COMP controls the flip-flop FF2 to reset the flip-flop FF1 to have the output terminal Q of the flip-flop FF1 switched from high level voltage to low level voltage so as to turn off the switch Q3. In this way, the knee voltage of the feedback voltage VFB is held in the capacitor C0.

In addition, under the influence of the inductance of the auxiliary windings P3 and the magnitude of the load, there may exist several pulses higher than the reference voltage VREF3 within one oscillation cycle after the feedback voltage VFB being smaller than the reference voltage VREF3 for the first time. Such effect may cause the voltage sampling and holding controller 10a wrongly act. To solve this problem, the driving signal DRV outputted by the switch controller 14 can be used to control the flip-flop FF2 in the voltage sampling and holding controller 10a to have the voltage sampling and holding controller 10a accept only the first knee voltage in the feedback voltage VFB.

FIG. 11B shows a diagram of a second embodiment of the feedback signal processor according to the present invention. Referring to FIG. 10B in conjunction with FIGS. 3 to 6, the feedback signal processor 10 is a voltage sampling and holding controller 10b and comprises a plurality of sampling and holding control circuits 106 and a sampling optimization circuit 108. Each sampling and holding control circuit 106 is coupled to the auxiliary winding P3 or the secondary winding P2 of the transformer T1 and respectively samples the feedback voltage VFB at different time from the auxiliary winding P3 or the secondary winding P2. Besides, each sampling and holding control circuit 106 compares the sampled feedback voltage VFB with a respective reference voltages VREF-1˜VREF-n and further generates different sampling voltages Vsamp-1˜Vsamp-n representing the slope of the waveform of the feedback voltage VFB. The sampling optimization circuit 108 is coupled to these sampling and holding control circuits 106 for receiving the sampling voltages Vsamp-1˜Vsamp-n and calculating a knee voltage of the feedback voltage VFB based these sampling voltages Vsamp-1˜Vsamp-n so as to generate a feedback signal VS.

Furthermore, since the feedback voltage VFB is affected by the inductance of the auxiliary winding P3 and the magnitude of the load. When the auxiliary winding P3 is working in non-continuous mode, it is hard to precisely acquire the knee voltage of the harmonic wave voltage, as a result, it is required to optimize the knee voltage acquired by the sampling and holding control circuits 106 so as to improve the drawback that the voltage feedback of the primary side feedback control switching power supply is less precise than that of the secondary side feedback control switching power supply.

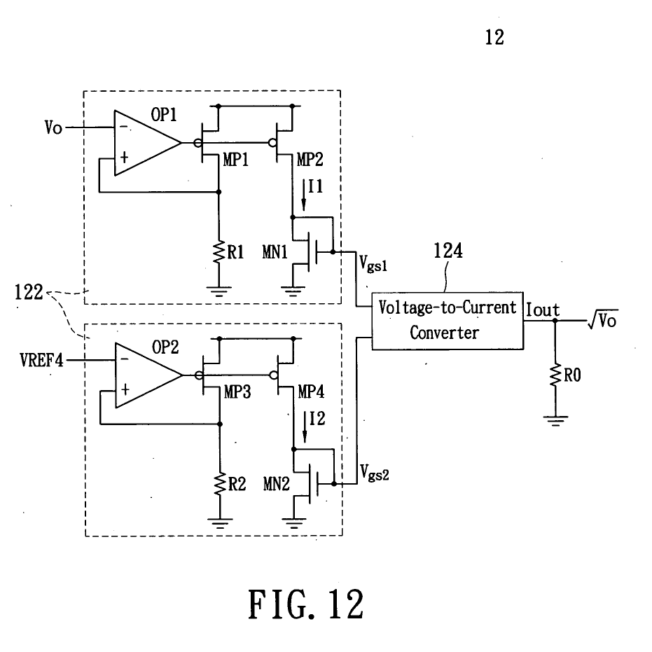

FIG. 12 is a circuit diagram of the square-root generator according to the present invention is shown. Referring to FIG. 12 in conjunction with FIGS. 3 to 6, the square-root generator 12 adopts the feature of MOS to have the output voltage V_{O} and the reference VREF4 input into two identical current generating circuits 122 and thus generate the voltage VGS1 and voltage VGS2 respectively. Then, the voltage VGS1 and voltage VGS2 are inputted to a voltage-to-current converting circuit 124 to precisely generate the output current I_{OUT}=√ (I1×I2). The output current I_{OUT} is then multiplied by the output resistance R_{O} to get the square-root output voltage √ V_{O}.

As illustrated above, when the auxiliary winding or secondary winding working in non-continuous mode, the above mentioned embodiments of the present invention is capable to acquire the precise knee voltage by using the voltage sampling and holding controller to sample the feedback voltage as feedback control. And it also allows the entire switching power supply apparatus to achieve the objective of over-current protection by using the square-root generator to have the output current to be kept unchanged when the output current reaches the current limit and the output voltage descends.

The aforementioned illustrations have described the preferred embodiments of the present invention, but the characteristics of the present invention are by no means limited thereto. Any changes or modifications that skilled ones in the art can conveniently consider are all deemed to be encompassed by the scope of the present invention delineated by the following claims.

What is claimed is:

1. A switching power supply apparatus with current output limit, comprising:
a transformer, having a primary winding, a secondary winding, and an auxiliary winding, receiving an input voltage by the primary winding, inductively outputting an output voltage from the secondary winding, and inductively outputting a feedback voltage from the auxiliary winding;
a power switch, coupled to the primary winding of the transformer;
a current detector, coupled to the power switch, receiving a current from the primary winding of the transformer through the power switch, and outputting a current detection signal;
a feedback signal processor, coupled to the auxiliary winding of the transformer, and generating a feedback signal based on the feedback voltage;
a square-root generator, coupled to the feedback signal processor, performing square-root computation to the feedback signal, and outputting a current limit control signal; and
a switch controller, coupled to the power switch, the square-root generator, and the current detector, and comparing the current detection signal with the current limit control signal when in a protection status, and outputting a driving signal to the power switch based on comparison result to control switching of the power switch.

2. The switching power supply apparatus with current output limit according to claim 1, further comprising an error amplifier, coupled to the feedback signal processor, comparing a reference voltage with the feedback signal, and outputting an amplified error signal.

3. The switching power supply apparatus with current output limit according to claim 2, wherein the feedback signal processor is a voltage sampling and holding controller, for sampling the feedback voltage and holding the feedback voltage for generating the feedback signal.

4. The switching power supply apparatus with current output limit according to claim 2, further comprising a voltage level adjuster, coupled to the error amplifier and the switch controller, for receiving the amplified error signal and outputting a voltage control signal to the switch controller.

5. The switching power supply apparatus with current output limit according to claim 4, wherein the switch controller comprises:
a comparator, which has a first inverting input terminal, a second inverting input terminal, a non-inverting input terminal, and an output terminal, wherein the first inverting input terminal receives the current limit control signal, the second inverting input terminal receives the voltage control signal, the non-inverting input terminal receives the current detection signal, and the output terminal outputs a cut-off signal when the current detection signal is greater than the current limit control signal or the current detection signal is greater than the voltage control signal;
a noise eliminator, coupled to the output terminal of the comparator and a control end of the power switch, outputting a noise elimination signal based on the cut-off signal to the control end of the power switch, and outputting the cut-off signal after outputting the noise elimination signal;
an over-voltage protection device, outputting a protection signal;
an oscillator, outputting a conducting signal;
an OR gate, coupled to the noise eliminator and the over-voltage protection device, performing logical OR operation on the cut-off signal and the protection signal in order to output a reset signal;
a flip-flop, which has a setup terminal, a reset terminal, and an output terminal, wherein the reset terminal is coupled to an output terminal of the OR gate, the setup terminal is coupled to the oscillator, the flip-flop receiving the conducting signal and the reset signal and outputting a control signal through the output terminal; and
a driver, coupled to the output terminal of the flip-flop and the power switch for receiving the control signal and outputting the driving signal to the power switch.

6. The switching power supply apparatus with current output limit according to claim 5, wherein the switch controller further comprises a phase shift circuit, coupled to the output terminal of the flip-flop and the feedback signal processor, and outputting a blank signal to the feedback signal processor.

7. The switching power supply apparatus with current output limit according to claim 3, wherein the voltage sampling and holding controller comprises:
a plurality of sampling circuits, coupled to the auxiliary winding of the transformer, sequentially sampling the feedback voltage and outputting a plurality of sampling voltages; and
a calculation circuit, coupled to the plurality of sampling circuits, outputting a knee voltage of the feedback voltage based on the plurality of sample voltages.

8. A switching power supply apparatus with current output limit, comprising:
a transformer, having a primary winding and a secondary winding, receiving an input voltage by the primary winding and inductively outputting an output voltage and a feedback voltage from the secondary winding;
a power switch, coupled to the primary winding of the transformer;
a current detector, coupled to the power switch, receiving a current from the primary winding of the transformer through the power switch, and outputting a current detection signal;
a feedback signal processor, coupled to the secondary winding of the transformer, and generating a feedback signal based on the feedback voltage;
a square-root generator, coupled to the feedback signal processor, and performing square-root computation on the feedback signal and outputting a current limit control signal; and
a switch controller, coupled to the power switch, the square-root generator, and the current detector, comparing the current detection signal with the current limit control signal when in a protection status, and outputting a driving signal to the power switch based on comparison result in order to control switching of the power switch.

9. The switching power supply apparatus with current output limit according to claim 8, further comprising an error amplifier, coupled to the feedback signal processor, comparing a reference voltage with the feedback signal, and outputting an amplified error signal.

10. The switching power supply apparatus with current output limit according to claim 9, wherein the feedback signal processor is a voltage sampling and holding controller, for sampling the feedback voltage and holding the feedback voltage for generating the feedback signal.

11. The switching power supply apparatus with current output limit according to claim 9, further comprising a voltage level adjuster, coupled to the error amplifier and the switch controller, for receiving the amplified error signal and outputting a voltage control signal to the switch controller.

12. The switching power supply apparatus with current output limit according to claim 11, wherein the switch controller comprises:
a comparator, which has a first inverting input terminal, a second inverting input terminal, a non-inverting input terminal, and an output terminal, wherein the first inverting input terminal receives the current limit control signal, the second inverting input terminal receives the voltage control signal, the non-inverting input terminal receives the current detection signal, and the output terminal outputs a cut-off signal when the current detection signal is greater than the current limit control signal or the current detection signal is greater than the voltage control signal;
a noise eliminator, coupled to the output terminal of the comparator and a control end of the power switch, outputting a noise elimination signal based on the cut-off signal to the control end of the power switch, and outputting the cut-off signal after outputting the noise elimination signal;
an over-voltage protection device, outputting a protection signal;
an oscillator, outputting a conducting signal;
an OR gate, coupled to the noise eliminator and the over-voltage protection device, performing logical OR operation on the cut-off signal and the protection signal in order to output a reset signal;
a flip-flop, which has a reset terminal, a setup terminal, and an output terminal, wherein the reset terminal is coupled to an output terminal of the OR gate, the setup terminal is coupled to the oscillator, and the flip-flop receives the conducting signal and the reset signal and outputting a control signal through the output terminal; and
a driver, coupled between the output terminal of the flip-flop and the power switch for receiving the control signal and outputting the driving signal to the power switch.

13. The switching power supply apparatus with current output limit according to claim 12, wherein the switch controller further comprises a phase shift circuit, coupled to the output terminal of the flip-flop and the feedback signal processor, and outputting a blank signal to the feedback signal processor.

14. The switching power supply apparatus with current output limit according to claim 10, wherein the voltage sampling and holding controller comprises:
a plurality of sampling circuits, coupled to the secondary winding of the transformer, sequentially sampling the feedback voltage and outputting a plurality of sample voltages; and
a calculation circuit, coupled to the plurality of sampling circuits, outputting a knee voltage of the feedback voltage based on the plurality of sample voltages.

15. A controller, which is coupled to a power supply circuit, comprising:
a feedback signal processor, coupled to the power supply circuit, receiving a feedback voltage from the power supply circuit and generating a feedback signal based on the feedback voltage;
a square-root generator, coupled to the feedback signal processor, performing square-root computation on the feedback signal, and outputting a current limit control signal; and
a switch controller, coupled to the square-root generator and the power supply circuit, receiving a current detection signal from the power supply circuit, comparing the current detection signal with the current limit control signal when in a protection status and outputting a driving signal to the power supply circuit based on comparison result in order to control switching of the power switch.

16. The controller according to claim 15, further comprising an error amplifier, coupled to the feedback signal processor, comparing a reference voltage with the feedback signal, and outputting an amplified error signal.

17. The controller according to claim 16, wherein the feedback signal processor is a voltage sampling and holding controller, coupled to the power supply circuit, for sampling the feedback voltage and holding the feedback voltage for generating the feedback signal.

18. The controller according to claim 16, further comprising a voltage level adjuster, coupled to the error amplifier and the switch controller, receiving the amplified error signal, and outputting a voltage control signal to the switch controller.

19. The controller according to claim 18, wherein the switch controller comprises:
a comparator, which has a first inverting input terminal, a second inverting input terminal, a non-inverting input terminal, and an output terminal, wherein the first inverting input terminal receives the current limit control signal, the second inverting input terminal receives the voltage control signal, the non-inverting input terminal receives the current detection signal, and the output terminal outputs a cut-off signal when the current detection signal is greater than the current limit control signal or the current detection signal is greater than the voltage control signal;
a noise eliminator, coupled to the output terminal of the comparator and a control end of the power switch, outputting a noise elimination signal based on the cut-off signal to the control end of the power switch, and outputting the cut-off signal after outputting the noise elimination signal;
an over-voltage protection device, outputting a protection signal;
an oscillator, outputting a conducting signal;
an OR gate, coupled to the noise eliminator and the over-voltage protection device, performing logical OR operation on the cut-off signal and the protection signal in order to output a reset signal;
a flip-flop, which has a reset terminal, a setup terminal, and an output terminal, wherein the reset terminal is coupled to an output terminal of the OR gate, the setup terminal is coupled to the oscillator, the flip-flop receives the conducting signal and the reset signal and outputs a control signal through the output terminal; and
a driver, coupled to the output terminal of the flip-flop and the power switch for receiving the control signal and outputting the driving signal to the power switch.

20. The controller according to claim 17, wherein the switch controller further comprises a phase shift circuit, coupled to the output terminal of the flip-flop and the voltage sampling and holding controller, outputting a blank signal to the voltage sampling and holding controller.

21. The controller according to claim 17, wherein the voltage sampling and holding controller comprises:
a plurality of sampling circuits, coupled to the power supply circuit, sequentially sampling the feedback voltage and outputting a plurality of sampling voltages; and
a calculating circuit, coupled to the plurality of sampling circuits, outputting a knee voltage of the feedback voltage based on the plurality of sampling voltages.
